(19) United States
(12) Patent Application Publication
(10) Pub. No.: US 2008/0010297 A1
(43) Pub. Date: Jan. 10, 2008

(54) WEB-BASED DIALING

(76) Inventors: David Elliot GOLDFARB, Beit Shemesh (IL); David G.M. JACOBSON, Haela (IL)

Correspondence Address: DANIEL J SWIRSKY, 55 REUVEN ST., BEIT SHEMESH, 99544, omitted

(21) Appl. No.: 11/775,248

(22) Filed: Jul. 10, 2007

Related U.S. Application Data
(60) Provisional application No. 60/819,394, filed on Jul. 10, 2006.

(51) Int. Cl. G06F 17/30

(52) U.S. Cl. 707/10

(57) ABSTRACT

A mobile communications device includes a unit to receive a telephone number downloaded from a web page and a dialing mechanism to dial the telephone number. Also included is a web-based contact list with phone numbers which are selectably downloadable to at least one mobile communications device.

### CROSS-REFERENCE TO RELATED APPLICATIONS

This application claims benefit from U.S. Provisional Patent Application 60/819,394, filed Jul. 10, 2006, which is hereby incorporated in its entirety by reference.

### FIELD OF THE INVENTION

The present invention relates generally to systems and methods of dialing telephones.

### BACKGROUND OF THE INVENTION

There are many ways to place a telephone call to another person. In the traditional method, the originator can pick up his telephone handset and dial the phone number of the other person. Such a phone call is transmitted on the PSTN (public switched telephone network) from a POTS (plain old telephone system) telephone.

Alternatively, the originator may dial his friend on his cellular telephone, using his friend's “landline” number (i.e., PSTN number) or his friend's cellular phone number. The former will pass through both the PSTN and the cellular systems while the latter conversation will occur only through the cellular telephone system. The originator can dial the number or can search the contact list on his cellular telephone, clicking when he finds either the correct number or a contact list entry for his friend.

The originator may further utilize his “desktop soft phone”, which operates on his computer, dialing through a VoIP (voice over internet protocol) connection. The originator may directly dial the phone number into the desktop phone. Alternatively, he may find the contact information of the person to be dialed, possibly via a contact organizer program such as Outlook (commercially available from Microsoft Corporation of the USA). In this latter case, the originator may select, possibly from a long list of phone numbers for the person, the particular phone number to be dialed. The contact organizer program then provides the phone number to the desktop phone which, in turn, dials the phone number.

Some cell phones can utilize the contact list stored in the organizer program and can synchronize with the desktop computer remotely (via Bluetooth, SyncML Server, etc). This reduces the need to maintain multiple contact lists but is a security risk. If the cellular phone is lost, the finder will have access to the user's entire contact list. Moreover, the user may have to re-enter the entire contact list into his new phone.

For long contact lists, the organization of the contact list becomes paramount and few cellular telephones provide anything other than an alphabetic organization.

VoIP phones can be utilized for other purposes as well. Internet RFC 2458 defines a protocol which allows websites to provide “click-to-dial” access, e.g. to a help center; based on SIP (Session Initiation Protocol). The user visiting the website may click on the phone number of the help center and may be connected, through his VoIP phone, to the help center. Such a “click-to-dial” process connects the VoIP phone, through the browser, with the VoIP server or other telephone system of the help center.

### SUMMARY OF THE PRESENT INVENTION

There is provided, in accordance with a preferred embodiment of the present invention, a method for a mobile communications device. The method includes receiving a file of a phone number MIME type from a web page viewed by the mobile communications device, activating a parser associated with the MIME type, the parser to parse the file to select a relevant phone number from at least one phone number listed in the file and activating a dialing function of the mobile communications device to dial the selected phone number.

There is also provided, in accordance with a preferred embodiment of the present invention, apparatus including a parser and a dialing function. The parser is installable on a mobile communications device and definable for a phone number MIME type and parses phone number files downloaded from a web page. The dialing function dials a selected parsed phone number.

Moreover, in accordance with a preferred embodiment of the present invention, the mobile communications device is a cellular telephone, a hand-held device, or a Blackberry type device.

There is also provided, in accordance with a preferred embodiment of the present invention, a method including providing a web-based contact list for a company, the contact list including phone numbers selectably downloadable to at least one mobile communications device.

Additionally, in accordance with a preferred embodiment of the present invention, the method also includes refusing access to the contact list to mobile communications devices defined as one of: stolen and lost.

Moreover, in accordance with a preferred embodiment of the present invention, the web-based contact list forms part of corporate security for the company.

Further, in accordance with a preferred embodiment of the present invention, the method also includes providing editing access to the contact list to employees of the company.

Still further, in accordance with a preferred embodiment of the present invention, the contact list is in one format and the providing includes converting the one format to a format readable by the mobile communications device.

There is also provided, in accordance with a preferred embodiment of the present invention, a method including converting at least one phone number in an Internet-based contact management system to a format readable by a mobile communications device and providing at least one phone number on a web page, the at least one phone number being selectably downloadable to at least one mobile communications device.

Further, in accordance with a preferred embodiment of the present invention, the providing includes adding calling codes to the at least one phone number in the Internet-based contact management system.

Still further, in accordance with a preferred embodiment of the present invention, the providing includes also providing content related to the phone number. The content may be a name associated with the phone number, contact information associated with the phone number or personalization content associated with the phone number. The personalization content may chosen by a user of the web page or by his buddy.

There is also provided, in accordance with a preferred embodiment of the present invention, a mobile communications device including a unit to receive a telephone number downloaded from a web page and a dialing mechanism to dial the telephone number.

Additionally, in accordance with a preferred embodiment of the present invention, the unit includes a web browser capable of receiving a telephony URL.

Moreover, in accordance with a preferred embodiment of the present invention, the unit includes a downloaded phone number dialer.

There is also provided, in accordance with a preferred embodiment of the present invention, a method including providing on a web page at least one phone number and at least personalization content of a buddy of a user of the web page, the at least one phone number being selectably downloadable to at least one mobile communications device.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 is a schematic illustration of a cell phone of the present invention and its communication with a website;

FIG. 2 is a detailed schematic illustration of the cell phone of FIG. 1;

FIG. 3 is a schematic illustration of a file, useful in the cell phone of FIG. 1;

FIG. 4 is a schematic illustration of an alternative embodiment of the system of FIG. 1;

FIGS. 5A and 5B are schematic illustrations of the generation of a contact list webpage for the system of FIG. 4; and

FIG. 6 is a schematic illustration of a media content sharing page, using the system of FIG. 1 or FIG. 4.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE PRESENT INVENTION

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

Unless specifically stated otherwise, as apparent from the following discussions, it is appreciated that, throughout the specification, discussions utilizing terms such as “processing,” “computing,” “calculating,” “determining,” or the like, refer to the action and/or processes of a computer, computing system, or similar electronic computing device that manipulates and/or transforms data represented as physical, such as electronic, quantities within the computing system's registers and/or memories into other data similarly represented as physical quantities within the computing system's memories, registers or other such information storage, transmission or display devices.

The present invention may provide web-based dialing for mobile communications devices. Thus, a user may view a web page from his mobile device, click on a desired telephone number and the mobile device may dial the selected telephone number.

This may enable the user to maintain a web-based contact list which may be edited and organized in any desired format, such as HTML, etc. It may enable organizations to maintain contact list(s) for their employees, associates, etc. Since the contact list(s) may exist only on the web, losing a mobile communications device may no longer mean leaking the contact list to others, nor may it require reentering the numbers into a new mobile device. Furthermore, web servers may refuse to respond to lost telephones, thereby further increasing security.

It will be appreciated that the present invention may provide mobile access to telephone numbers. Wherever a user may be, he may connect to the web and find a desired telephone number, which his mobile device may then dial. For example, while on the train, a user may search the web for a restaurant. When he reaches the relevant web page, he may click on the telephone number and his mobile device may connect him to the restaurant.

It will be appreciated that the present invention is applicable to all mobile communications devices that can connect to the web. Such devices include, in addition to high end cellular telephones: Blackberries, commercially available from Research in Motion of Canada; and computer phones on mobile devices, such as iPAQs, commercially available from Hewlett-Packard of the US, and other hand-held devices.

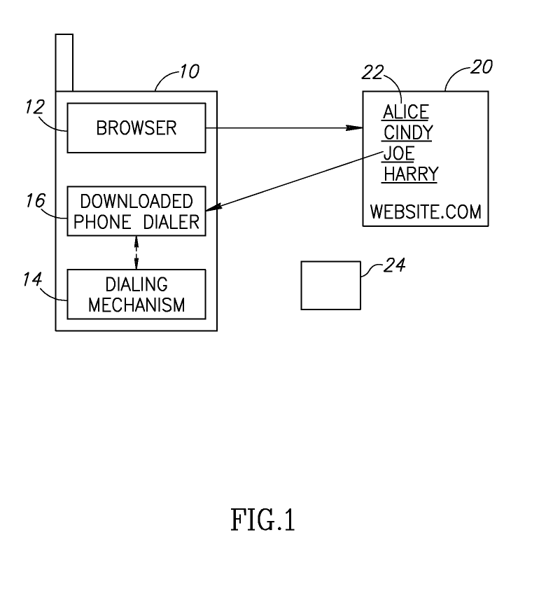

Reference is now made to FIG. 1, which conceptually illustrates the present invention. A mobile device 10 may have two pre-installed applications, a web browser 12 and an internal dialing mechanism 14. In accordance with a preferred embodiment of the present invention, mobile device 10 may also comprise a downloaded phone number dialer (DPND) 16 which may operate in conjunction with browser 12 and dialing mechanism 14.

The user may use web browser 12 to access a web page 20 at, for example, “website.com”. Web page 20 may include a list 22 of names, each linked (as noted by the underlining) to a separate file. When the user clicks (within browser 12) on one of the names, for example, on “Joe”, a file 24, which may include a telephone number associated with the clicked name, may be downloaded to telephone 10. DPND 16 may parse the downloaded telephone number and may activate dialer 14 to dial at least one of the numbers listed in file 24.

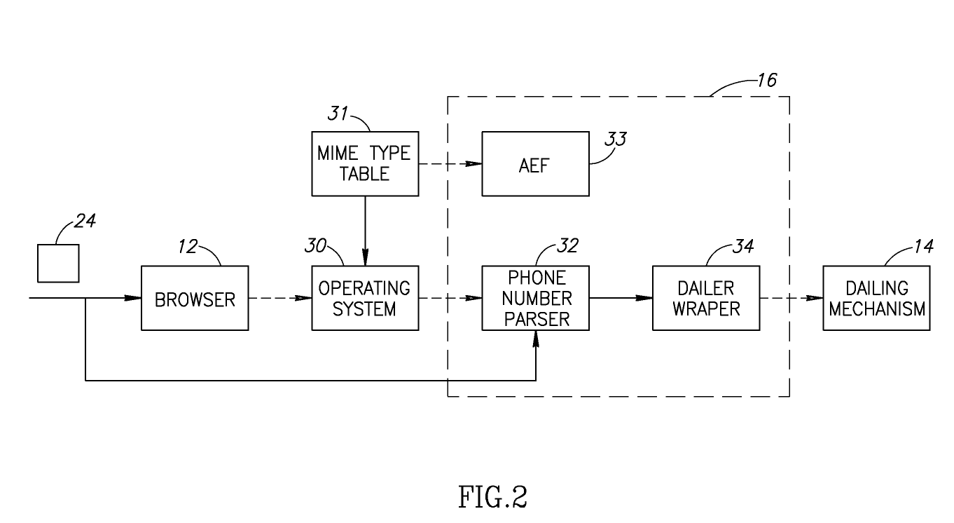

Reference is now made to FIG. 2, which illustrates the cooperation between browser 12, dialing mechanism 14 and DPND 16. In addition to dialing mechanism 14 and browser 12, mobile device 10 may also have a pre-installed operating system 30, such as the Symbian operating system, which may operate with an associated MIME type table 31. DPND 16 may comprise a phone number parser 32 and a wrapper 34 around internal dialing mechanism 14.

MIME type table 31 may form a part of operating system 30 and may list MIME (multi-purpose internet mail extensions) types known by operating system 30, where a MIME type may describe both the type of the file (text, XML, .pdf, etc.) and the type of application which may open it. In accordance with a preferred embodiment of the present invention, the present invention may define a new MIME type and associated file extension, for example “.fcp”, and may register DPND 16 as the handler for it.

DPND 16 may have associated with it an AEF (access control enforcement function) file 33 which may define the MIME type to be associated with parser 32, in this case, the new MIME type. Upon installation of DPND 16 into mobile device 10, operating system 30 may read AEF file 33 and may associate DPND 16 with its MIME type (for example, *.fcp) in MIME type table 31.

When browser 12 may request file 24, the server of web page 20 may provide file 24, together with an indication of its MIME type. In response, browser 12 may call operating system 30 to open the appropriate application for file 24. System 30 may access table 31 to check the application associated with the MIME type of file 24 and, using the output of table 31, may open DPND 16 on top of browser 12. Parser 32 may then parse file 24 to determine the phone number to be dialed. Parser 32 may then invoke wrapper 34 to dial the received phone number, typically by invoking a dialing API (application programming interface) of mobile device 10, which, in turn, may activate dialing mechanism 14.

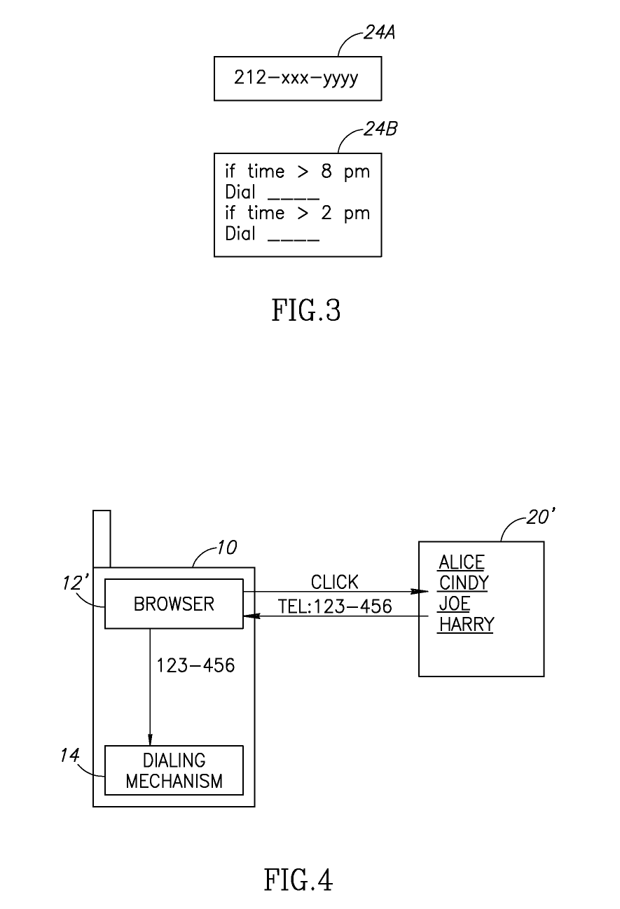

It will be appreciated that file 24 may contain the phone number to be dialed and/or logic describing how to reach the person with whom the file is associated. FIG. 3 to which reference is now made, illustrate two alternative files 24A and 24B.

File 24A may contain just the phone number, for example 212-xxx-yyyy. Alternatively, it might contain some code for which parser 32 might search, such as “//:PHONENUMBER://”, followed by the phone number.

File 24B might contain some logic describing which phone number to utilize. For example, there might be one phone number for late in the evening (after 8 pm) and a different phone number for the afternoon (after 2 pm). It will be appreciated that any type of logic may be written. The choice might be among times, or as a function of the calling phone number (i.e. a different number to call depending on who calls), or as a function of the region of the calling number (i.e. a different number for different parts of the country), or of the presence status (online, busy, away, etc.) of the called party, etc.

In an alternative embodiment, shown in FIG. 4, to which reference is now briefly made, no client software, such as DPND 16, may be required. In this embodiment, mobile device 10 may comprise web browser 12′ which may support URLs for telephone calls (RFC 2806). Exemplary devices which support RFC 2806 may include the 6680 and N70, commercially available from Nokia of Finland.

For this embodiment, web page 20′ may include a telephony URL linked (as noted by the underlining) to each person listed on the page. The telephony URL may read:

href=“tel:+1 212 xxx yyyy”

When the user clicks (within browser 12′) on one of the names, for example, on “Joe”, web page 20′ may provide the telephony URL “tel:212-xxx-yyyy” to browser 12′. Browser 12′ may then provide the telephone number “212-xxx-yyyy” to dialing mechanism 14.

It will be appreciated that the web-based contact list may be generated in any suitable way. For commercial websites, there may only be a few listed phone numbers, placed when designing the website. For company intranets or Wikis, the contact list may be generated by the employees, as each employee adds or edits the phone numbers he utilizes. Alternatively, it may be the province of a particular employee or department.

The contact list may be organized and/or reorganized in any desired manner. As described hereinabove, there may be a separate file 24 for each contact in the contact list or a separate telephony URL for each contact.

It will be appreciated that editing the contact list may be fairly simple since it is a web-based list.

It will also be appreciated that other content may be listed on web page 20. For example, other contact information (such as address, name, title, etc.) may be listed.

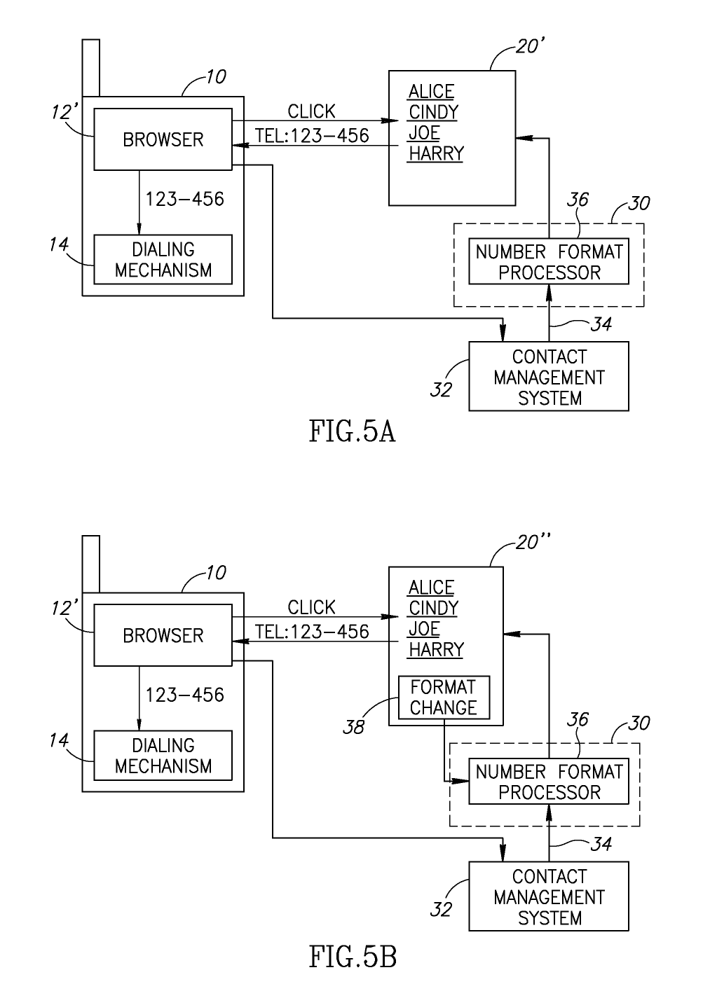

Reference is now made to FIGS. 5A and 5B, which illustrate two alternative embodiments of the present invention. Both embodiments take contact information from an external source and process the phone numbers thereon into a form usable by mobile device 10 for dialing.

The system shown in FIGS. 5A and 5B comprises mobile device 10 and a web server 30 connecting to an Internet-based database or contact management system 32, such as those of Plaxo, Salesforce.com, etc.

When browser 12′ of device 10 accesses contact management system 32, it does so by first contacting its web server 30 which, in turn, connects to contact management system 32. Web server 30 collects (arrow 34) contact information from contact management system 32 and then activates a number format processor 36 to convert any telephone numbers forming part of the contact information to one of the formats described hereinabove. Web server 30 then generates web page 20′ from the contact information from system 32 and the telephone formats of number format processor 36.

Number format processor 36 may scan the contact information, looking for telephone numbers in any known format. Number format processor 36 may have stored therein the multiplicity of formats for telephone numbers known throughout the world and may utilize such to find telephone numbers on webpage 34. When processor 36 may find a telephone number, it may either generate telephony URLs, as described hereinabove or it may link a file 24 to it, also as described hereinabove.

In the alternative embodiment shown in FIG. 5B, number format processor 36 may also generate telephone numbers in a form optimized for cheapest or otherwise more desirable dialing, based on the location and status of mobile device 10. In one embodiment, the webpage, here labeled 20″, may include a format change button 38. The user may click on button 38 and may select a change of format. Button 38 may indicate the format change to number format processor 36.

For one format change, number format processor 36 may include cheap dialing means which may receive the special codes that various telephone services require for inexpensive service. For example, Orange Israel offers a callback service which requires the user to dial the telephone number in the form it would be dialed domestically in Israel, but prefixed with “*00*” and followed by “#”. For example, the number +972 2 123-4567″ would be dialed as “*00*021234567#”. This triggers a callback service and greatly reduced calling rates.

Number format processor 36 may add the prefix and suffix codes to the telephone numbers found in web page 34 before generating telephony URLs, as described hereinabove or adding the link to file 24 to it, also as described hereinabove.

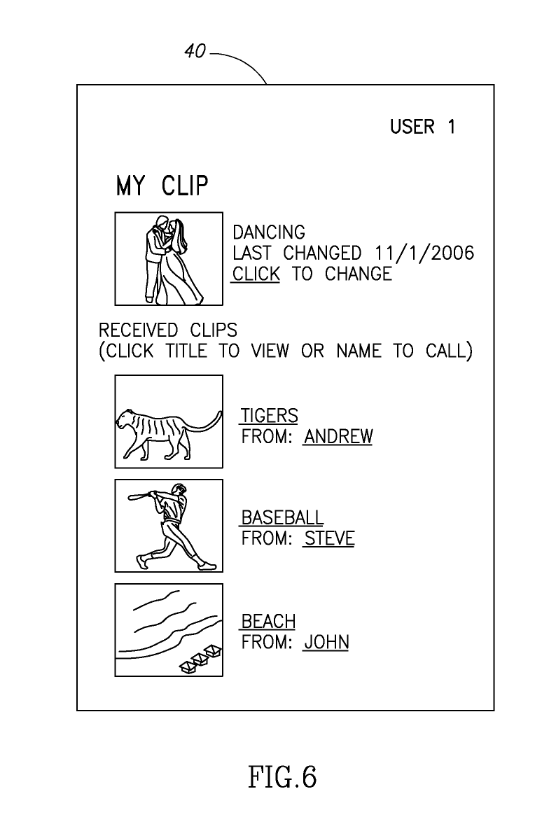

Reference is now made to FIG. 6, which illustrates a further embodiment of the present invention as part of a community server for a content-sharing community.

Prior patent applications U.S. 60/771,883 and 60/772,564, now incorporated into U.S. patent application Ser. No. 11/544,938, assigned to the common assignee of the present application and incorporated herein by reference, disclose a community server, an Internet-based server that allows users to choose media clips to be distributed to their buddies. These patent applications discuss a variety of opportunities to display a user's media clip to his buddy. For example, when the user and his buddy have or attempt to have a phone conversation. In addition, at the end of a call between two mobile devices, each might see video clip: one chosen by the user of that device, or one chosen by the user of the other device, or one chosen by the community server.

In accordance with an alternative preferred embodiment of the present invention, each member of the community may be issued a private web page 40, protected either by username/password, by a randomly-generated long URL, or by any other suitable means, as is clear to one skilled in the art. Page 40 may present a view of each of the user's buddies; offering the option to call each buddy (using the techniques described hereinabove), to play his latest media clip, or to view other information about him. These pages may also offer inexpensive dialing and the other options discussed in the previous embodiments.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

What is claimed is:

1. A method for a mobile communications device, the method comprising:
receiving a file of a phone number MIME type from a web page viewed by said mobile communications device;
activating a parser associated with said MIME type, said parser to parse said file to select a relevant phone number from at least one phone number listed in said file; and
activating a dialing function of said mobile communications device to dial said selected phone number.

2. The method according to claim 1 and wherein said mobile communications device is one of the following types: a cellular telephone, a hand-held device and a Blackberry type device.

3. Apparatus comprising:
a parser installable on a mobile communications device and definable for a phone number MIME type, said parser to parse phone number files downloaded from a web page; and
a dialing function to dial a selected parsed phone number.

4. The apparatus according to claim 3 and wherein said mobile communications device is one of the following types: a cellular telephone, a hand-held device and a Blackberry type device.

5. A method comprising:
providing a web-based contact list for a company, said contact list including phone numbers selectably downloadable to at least one mobile communications device.

6. The method according to claim 5 and also comprising refusing access to said contact list to mobile communications devices defined as one of: stolen and lost.

7. The method according to claim 5 and said web-based contact list forms part of corporate security for said company.

8. The method according to claim 5 and also comprising providing editing access to said contact list to employees of said company.

9. The method according to claim 5 and wherein said contact list is in one format and said providing comprises converting said one format to a format readable by said mobile communications device.

10. A method comprising:
converting at least one phone number in an Internet-based contact management system to a format readable by a mobile communications device; and
providing said at least one phone number on a web page, said at least one phone number being selectably downloadable to said mobile communications device.

11. The method according to claim 10 and wherein said mobile communications device is one of the following types: a cellular telephone, a hand-held device and a Blackberry type device.

12. The method according to claim 10 and wherein said providing comprises adding calling codes to said at least one phone number in said Internet-based contact management system.

13. The method according to claim 10 and wherein said providing comprises also providing content related to said phone number.

14. The method according to claim 13 and wherein said content is a name associated with said phone number.

15. The method according to claim 13 and wherein said content is contact information associated with said phone number.

16. The method according to claim 13 and wherein said content is personalization content associated with said phone number.

17. The method according to claim 16 and wherein said personalization content is chosen by a user of said web page.

18. The method according to claim 16 and wherein said personalization content is chosen by a buddy of a user of said web page.

19. A mobile communications device comprising:
means to receive a telephone number downloaded from a web page; and
a dialing mechanism to dial said telephone number.

20. The device according to claim 19 and wherein said means comprises a web browser capable of receiving a telephony URL.

21. The device according to claim 19 and wherein said means comprises a downloaded phone number dialer.

22. A method comprising:
providing on a web page at least one phone number and at least personalization content of a buddy of a user of said web page, said at least one phone number being selectably downloadable to at least one mobile communications device.

23. The method according to claim 22 and wherein said content is a name associated with said phone number.

24. The method according to claim 22 and wherein said content is contact information associated with said phone number.

25. The method according to claim 22 and wherein said personalization content is chosen by said user.

26. The method according to claim 22 and wherein said personalization content is chosen by said buddy.
